(19) United States
(12) Patent Application Publication
(10) Pub. No.: US 2014/0051877 A1
(43) Pub. Date: Feb. 20, 2014

(54) EICOSAPENTAENOIC ACID (EPA) AS POLYUNSATURATED FREE FATTY ACID IN ITS DIRECTLY COMPRESSIBLE POWDER FORM AND PROCESS OF ISOLATION THEREOF

(71) Applicant: Nandakishore Jeevanrao Duragkar, Nagpur (IN)

(72) Inventor: Nandakishore Jeevanrao Duragkar, Nagpur (IN)

(21) Appl. No.: 14/113,849

(22) PCT Filed: Apr. 27, 2012
(86) PCT No.: PCT/IN12/00310

§ 371 Date: Oct. 25, 2013

(30) Foreign Application Priority Data
Apr. 28, 2011 (IN) 952MUM/2011

(51) Int. Cl. C11C 1/00

(52) U.S. Cl. CPC C11C 1/002
USPC 554/199

(57) ABSTRACT

The present invention provides Eicosapentaenoic acid (EPA) in its free fatty acid form and a process of isolation thereof from oils and fats of natural origin having Eicosapentaenoic acid (EPA) attached to triglycerides. The EPA isolated using the process of the present invention is in free flowing powder form which is directly compressible. Further, the EPA in powder form is free from triglycerides. The EPA powder of the present invention has purity more than 90%. The EPA in its free fatty acid powder form offers excellent bioavailability and stability at room temperature.

### FIELD OF INVENTION

The present invention relates to Eicosapentaenoic acid (EPA) in its polyunsaturated free fatty acid, directly compressible powder form, and isolation of Eicosapentaenoic acid (EPA) from natural sources of oil or fats having Eicosapentaenoic acid (EPA) attached to triglycerides.

### BACKGROUND OF THE INVENTION

Eicosapentaenoic acid (EPA) is an omega-3 fatty acid that is obtained in the human diet by eating oily fish or fish oil e.g., cod liver, herring, mackerel, salmon, menhaden and sardine. It is also found in human breast milk. However, fish do not naturally produce EPA, but obtain it from the algae they consume. Microalgae are being developed as a commercial source. EPA is not usually found in higher plants, but it has been reported in trace amounts in purslane. The human body converts alpha-linolenic acid (ALA) to EPA, but this is much less efficient than the absorption of EPA from food containing it therefore an appropriate supply of which must be ensured.

Attempts were made to isolate EPA from various sources. The previously attempted research resulted into the free fatty acids, which are in the liquid form. Looking at the immense potential of this product in the commercial market, several attempts were made to incorporate these fatty acids in powder form by means of adsorption, encapsulation, spray drying the emulsion and direct drying of algae source of these fatty acids to get powder. The main concern in these cases were difficulty in achieving desired purity, desired levels of separation of fatty acids, stability of product and incorporation in the dry dosage forms and nutrition products along with limitations of compressibility. Therefore there was necessity to have EPA as Polyunsaturated free fatty acid in directly compressible form with an added advantage of stability at room temperature.

An U.S. Pat. No. 6,846,942 discloses a method for obtaining pure EPA and pure DHA from natural sources. These sources of DHA normally contains substantial amount of fatty acid residues, often as residues of triglyceride molecules, which dilutes the concentration of EPA in the oil. Other fatty acids are always present in larger amounts. The process involved in this patent involves saponification under controlled temperature of not exceeding 40° C., involves steps of purification which selectively led to a product which is a mixture of EPA and DHA in liquid form. It is very essential to add antioxidants at this stage to prevent oxidation of these fatty acids since in this form these fatty acids are highly unstable. Subsequently to separate EPA from DHA the Magnesium salts of EPA & DHA are prepared which relies mostly on fractional precipitation using varying solubility of these fatty acids as salts in different solvents at subzero temperature

An US Patent US 2008/0279935 A1 attempts to present EPA in a powder form. This form of EPA is an encapsulated EPA powder. Encapsulation of these fatty acids was a necessity for improving the handling properties of a liquid and sticky form fatty acids material. The material needs to be processed with so many components leading to dilution of fatty acids in these compositions. Moreover it does not offer fatty acids free from triglycerides. This material offered is in ester form and has almost five times less bioavailability. Since the material is microencapsulated, it cannot be directly compressible.

US Patent 2007/0059340 provides EPA food products, the process involves a Zinc coating to protect and stabilize the omega 3-fatty acids. These fatty acids are also in oil form and needs stabilization. However, it has all the disadvantages mentioned in the microencapsulation process.

The US Patent application 2010/0055191 discloses a method of providing EPA where a powder composition of a functional oil material is obtained by drying an emulsion composition and water soluble encapsulating agent. Due to unstable nature of EPA in oil form, efforts were made to stabilize EPA. However, it does not offer free flowing Pure polyunsaturated free fatty acid EPA and it has all the disadvantages mentioned in the microencapsulation process.

The EPA provided in prior art processes is either in form of liquid or liquid adsorbed on the powder. Any Such form of EPA till now cannot be used directly as a single constituent as polyunsaturated free fatty acid in directly compressible powder forms because of its inherent abovementioned problems. The available form of EPA renders it to be processed by some or other methods for getting its immense nutritional and curative benefits and therefore it was envisaged to offer a product which takes care of all the above mentioned problems through our process which is shorter, simpler and economical.

In our invention we get the high purity EPA as polyunsaturated free fatty acid in free flowing powder form which is directly compressible. which is substantially free from water. Being powder, it is found to be stable at room temperature and therefore, addition of antioxidants is not required. The process has minimum steps of purification and doesn't require subzero temperature at any stage for isolation of free fatty acid form of EPA. It is highly compatible and stable in any form of compositions like solid compositions, liquid compositions, powder compositions, tablets, capsules, gels and all other forms of formulations providing these polyunsaturated free fatty acid EPA.

The present invention seeks to provide a process of extraction and isolation of a pure polyunsaturated free fatty acid EPA in free flowing powder form which is directly compressible from its natural sources. Accordingly, there exist a need to provide EPA and method of preparation thereof which overcomes drawbacks of the prior art.

### OBJECTS OF THE INVENTION

An object of the present invention is to offer a unique form of the polyunsaturated free fatty acid in a directly compressible powder form (Solid) which is in its free fatty acid form.

Another object of the present invention is also to avoid the deficiencies in the prior art.

Yet another object of the present invention is also to provide pure EPA in free flowing powder form, which is directly compressible.

One more object of the present invention is to provide pure EPA as polyunsaturated free fatty acid form which is free from triglycerides.

Yet another object of the present invention is to provide EPA powder with purity of more than 90%.

Another object of the present invention is to provide EPA which is stable at room temperature.

One more object of the present invention is to provide EPA which offers excellent bioavailability.

### SUMMARY OF THE INVENTION

Accordingly, the present invention provide Eicosapentaenoic acid (EPA) a polyunsaturated free fatty acid in a free flowing directly compressible powder form and method of isolation of Eicosapentaenoic acid (EPA), and the method comprising:
a) Selecting any one of oils and fats from natural sources having EPA attached to triglycerides;
b) adding equal quantity of any one or mixture of alcoholic sodium hydroxide and potassium hydroxide to form a reaction mixture;
c) stirring the mixture, wherein the mixture separates into two layers;
d) discarding an upper layer containing lower fatty acids having less than 20 carbons, the triglycerides and other impurities;
e) adding a ketone to a lower layer of the two layer to form a second mixture;
f) stirring the second mixture for one hour;
g) keeping aside the second mixture to precipitate higher free fatty acids;
h) filtering the second mixture to separate the precipitate; Discard the solids in lower layer;
i) Allow settling in the filtrate to precipitate EPA in the filtrate;
j) Discard the solubles, which includes other impurities;
k) The precipitate is recovered as solidified EPA;
l) Give several washing to the solidified EPA with the ketone to remove the impurities and other polyunsaturated free fatty acids. Evaporate and recover the solvent. This leads to drying of the precipitated EPA at room temperature to form the crystalline mass;
m) The same is passed through the sieve to obtain a dry, directly compressible, free flowing powder of free fatty acid EPA thereof.

### BRIEF DESCRIPTION OF DRAWINGS

FIG. 1 illustrates a flowchart of a process of isolation of Eicosapentaenoic acid (EPA), in accordance with the present invention; and

FIGS. 2-6 illustrates a various spectrums of Eicosapentaenoic acid (EPA), in accordance with the present invention.

### DETAILED DESCRIPTION OF THE INVENTION

The foregoing objects of the present invention are accomplished and the problems and shortcomings associated with the prior art, techniques and approaches are overcome by the present invention as described below in the preferred embodiments.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

The present invention provides Eicosapentaenoic acid (EPA), and process of isolation thereof. The EPA isolated using the process of the present invention is in free flowing powder form. Further, the EPA in powder form is free from triglycerides. The EPA powder of the present invention has purity more than 90% and is stable at room temperature. The EPA offers excellent bioavailability.

In our invention we get the EPA free fatty acid as free flowing powder which is directly compressible. Being powder, it is found to be stable at room temperature and therefore, addition of antioxidants is not required. The method has minimum steps of purification and doesn't require subzero temperature at any stage for isolation of free fatty acid form of EPA.

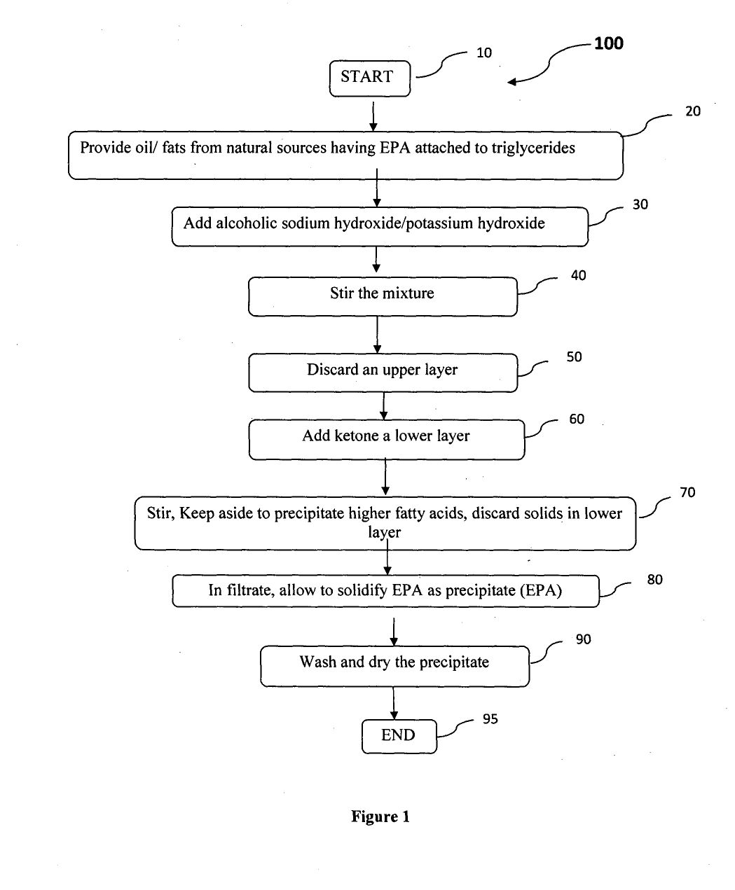

Referring now to FIG. 1, there is shown a flowchart of a process of isolation of the Eicosapentaenoic acid, (herein after ‘EPA’). Specifically, the FIG. 1 shows flowchart of the process (100). The process starts at step (10).

At step (20), the method (100) includes providing any one of oils and fats from natural sources having EPA attached to triglycerides. Initiate the method by maintaining the temperature of oil/fat to around 40-45° C.

At step (30), the method (100) includes adding equal quantity of any one or mixture of alcoholic sodium hydroxide and potassium hydroxide step (20) to form a reaction mixture. In an embodiment, the alcoholic solution of 1-2% sodium or potassium hydroxide is selected from methanolic, ethanolic, propanolic, butanolic sodium or potassium hydroxide and combination thereof.

At step (40), the method (100) includes moderately stirring the mixture for up to 30 min. Stirring lower downs temperature of the mixture. After stirring, it separates the mixture into two layers. The upper layer contains the lower fatty acids having less than 20 carbons, the triglycerides and other impurities.

At step (50), the method (100) includes discarding the upper layer.

At step (60), the method includes adding a ketone to the lower layer of the two layers in equal quantity to form a second mixture. In an embodiment, the ketone is selected from acetone, ethyl ketone, methyl ketone and the like.

At step (70), the process (100) includes stirring the second mixture for an hour and keep aside the second mixture for 30 minutes to precipitate higher free fatty acids. Discard the solids in lower layer.

At step (80), the process (100) includes filtering and allow settling to precipitate EPA in the filtrate. Discard the solubles, which includes other impurities. the precipitate is recovered as solidified EPA.

At step (90), the process (100) includes several washing to the solidified EPA with the ketone to remove the impurities and other polyunsaturated free fatty acids. Evaporate and recover the solvent. This leads to drying of the precipitated EPA at room temperature to form the crystalline mass. The same is passed through the sieve to obtain a dry, directly compressible, free flowing powder of free fatty acid EPA thereof. In an embodiment, the precipitate is washed with acetone.

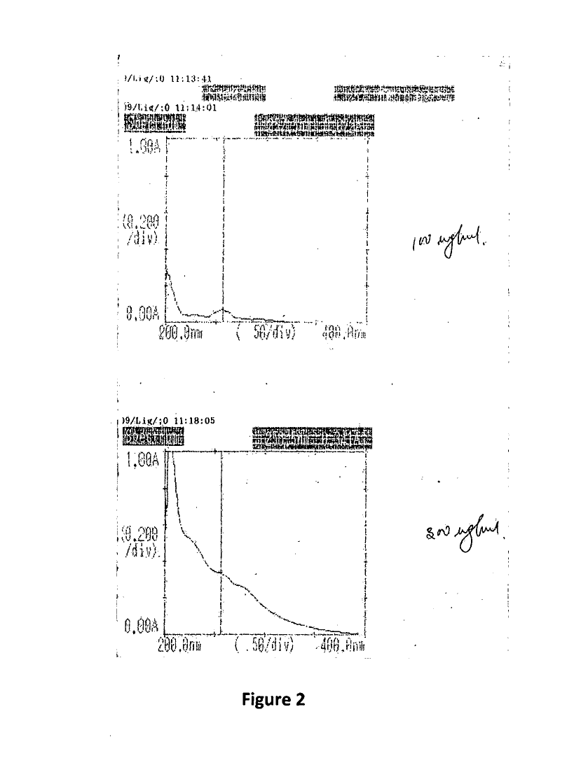

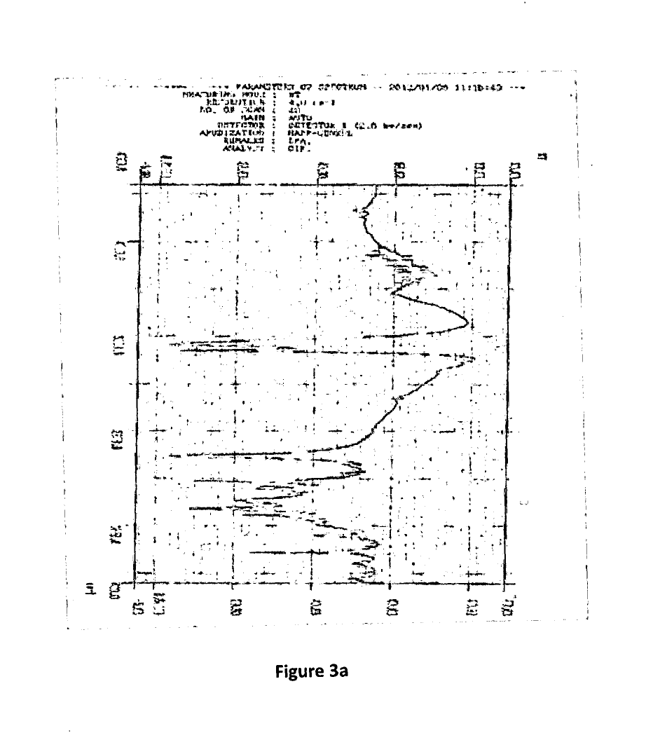

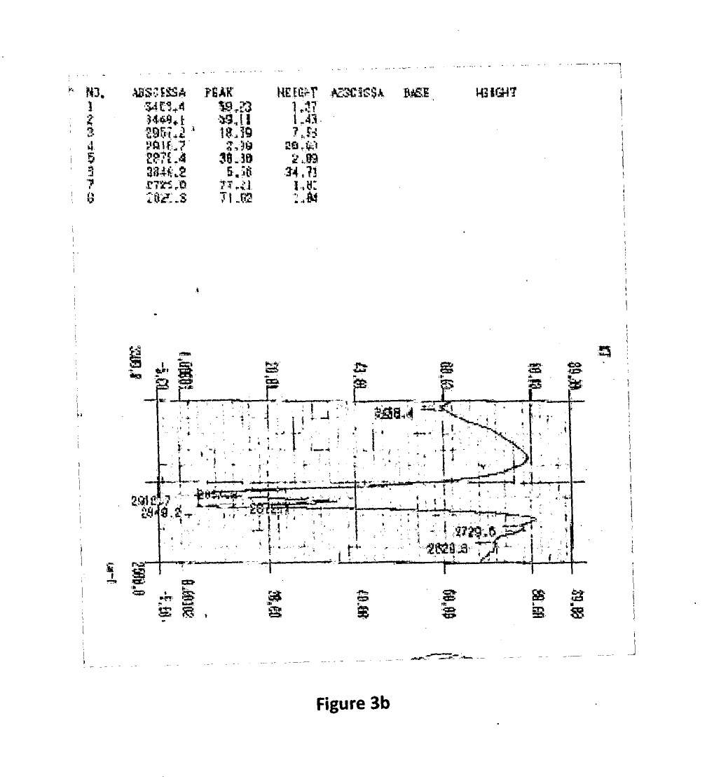

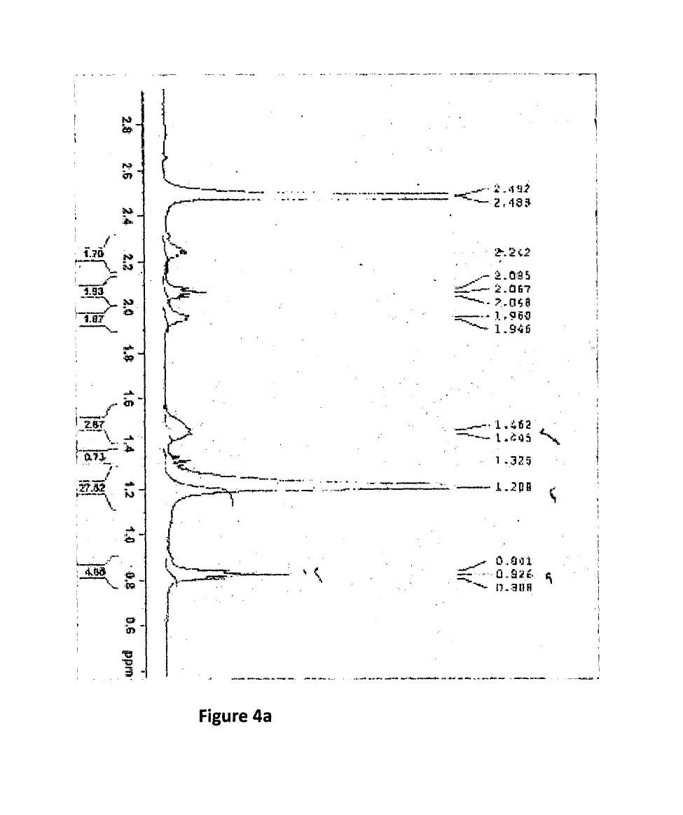

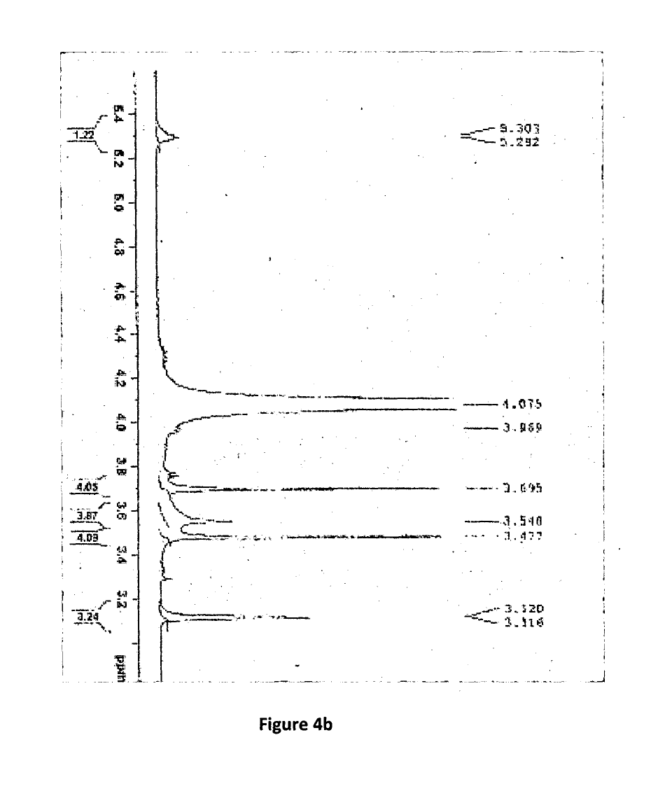

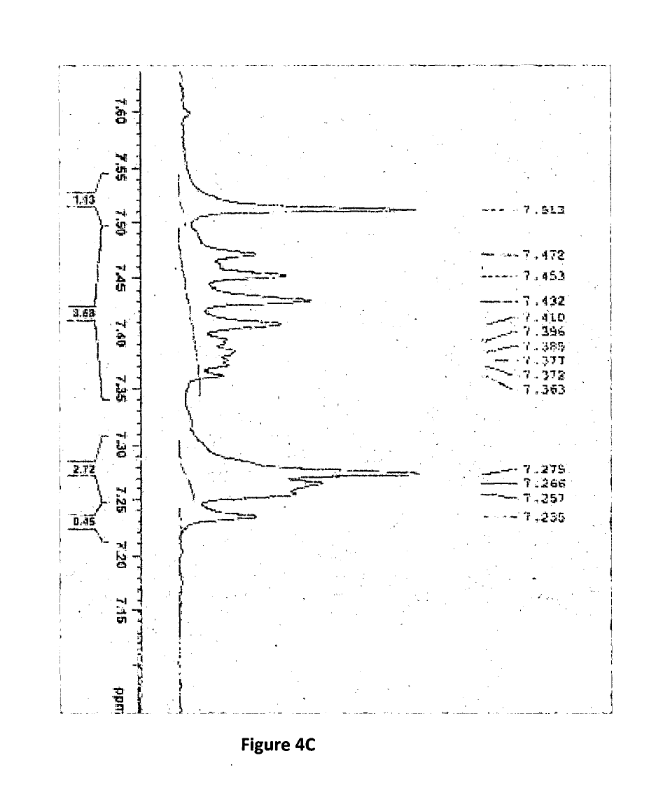

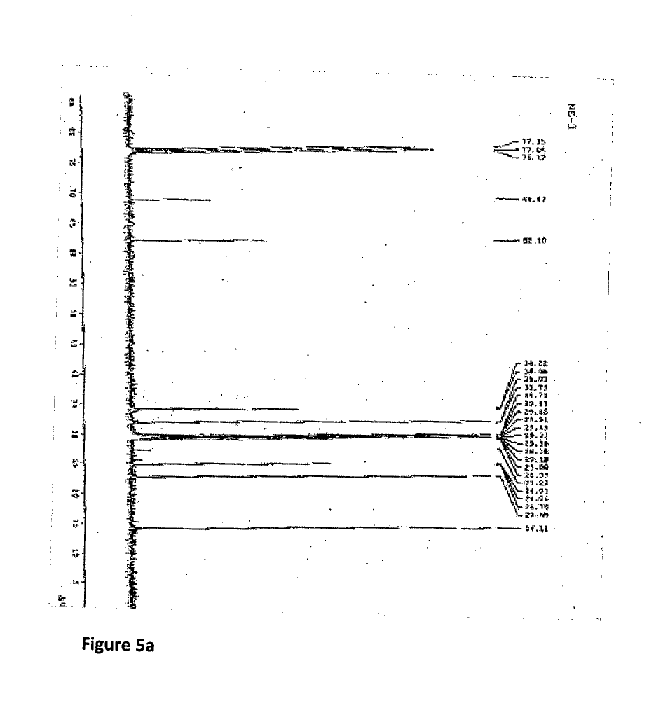

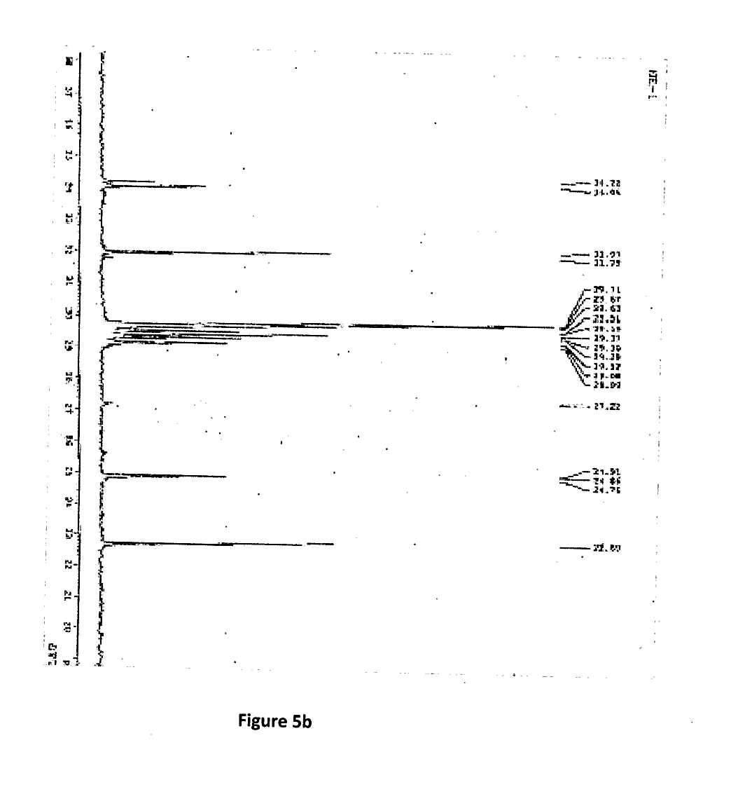

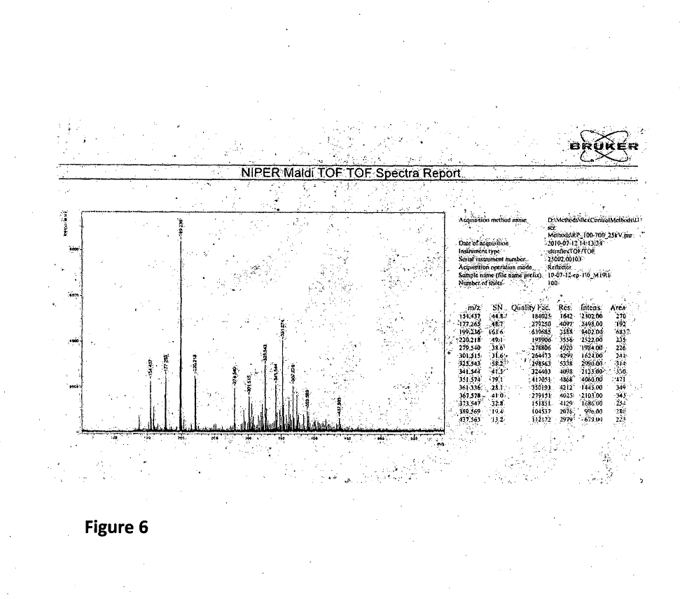

The EPA isolated using the above process is characterized by an UV spectrum (Chart 1, FIG. 2), IR spectrum (Chart 2, FIG. 3a, 3b), H-NMR spectrum (Chart 4, FIG. 4a, 4b, 4c), C13-NMR spectrum(Chart 3, FIG. 5a,5b), and Mass spectrum (Chart 5, FIG. 6) substantially similar to FIG. 2-6.

### EXAMPLE 1

Take 1 litre of fish oil. Maintain temperature to 40-45° C. To it add 1-2% methanolic or ethanolic or propanolic or butanolic sodium or potassium hydroxide 1 litre and stir for ½ an hour. keep aside, it separates into 2 layers, discard an upper layer which contains lower fatty acids. It further separates in to two layers, discard the upper layer. Then in lower layer add 750 ml of acetone or ethyl/ methyl ketone and stir for ½ an hour and keep aside for 20 mins. It precipitates and form two phase (solid and liquid) filter it and discard the solid layer. In the lower liquid layer, after ½ an hour, settle solid compound. On filtration, the solid compound separates. Wash the solid compound 2-3 times with 400 ml of acetone and Evaporate and recover the solvent with temperature not exceeding 40 degree C. This leads to drying of the precipitated EPA at room temperature to form the crystalline mass. The same is passed through the sieve to obtain a dry, directly compressible, free flowing powder of free fatty acid EPA thereof. The EPA is creamish or off-white crystalline solid powder having melting point 52-54 degree C., It is freely soluble in chloroform.

### EXAMPLE 2

Cool fish oil to 12 degree C. to solidify all fatty acids in waxy form which separates from the fish oil. Take 1 kg waxy fatty acids, Maintain temperature to 40-45° C., add 1 liter methanolic or ethanolic or propanolic or butanolic sodium or potassium hydroxide solution having concentration 1-2% Stir for ½ an hour. It separates into 2 layers. Discard the upper layer, and then add methanolic or ethanolic or propanolic or butanolic sodium or potassium hydroxide in equal proportion twice to separate remaining traces of fatty acid and stir for ½ an hour. To it add mixture of acetone and ethyle acetate 9:1 to 1:9 proportions. It further separates into two layers. The lower layer is solid layer and upper layer is liquid layer. Filter and discard the solids. Liquid layer after keeping at room temperature gets solidified and settle at the bottom of the container, which on filtration gives solid EPA. It is washed 2-3 times with equal quantity of acetone and Evaporate and recover the solvent with temperature not exceeding 40 degree C. This leads to drying of the precipitated EPA at room temperature to form the crystalline mass. The same is passed through the sieve to obtain a dry, directly compressible, free flowing powder of free fatty acid EPA thereof. The EPA is creamish or off-white crystalline solid powder having melting point 52-54 degree C., It is freely soluble in chloroform.

The spectral analysis for the EPA isolated using the process of the present invention is as follows.

CHART 1
Physical properties of the Isolated EPA and UV

| | | |
|---|---|---|
| M F(probable structure) | = | C₂₀H₃₀O₂ |
| Mol Wt | = | 302 (expected) |
| | = | 301.5 (observed in Mass) |

| Physical characterisation of given sample | |
|---|---|
| Colour | off-white |
| Odour | fishy smell |
| Texture | waxy |
| Solubility | Chloroform |
| Melting Point | 52-54° C. |
| 1. UV/VIS | |

λ = 256.5 nm
This value indicates the presence of unsaturation.

CHART 2
Infrared Spectral Interpretation of EPA
2. IR spectral Interpretation

| | Peak Value Observed | Expected range | | Inference |
|---|---|---|---|---|
| 1. | 3468.4 cm⁻¹ | (3600-3100 | cm⁻¹) | carboxylic <OH |
| | | | | stretching frequency |
| 2. | 2957.2 cm⁻¹ | (2700-3050 | cm⁻¹) | allphatic region and |
| | | | | —CH3, —CH2, |
| | | | | —CH stretch |
| | 2916.7 cm⁻¹ | | | |
| | 2849.2 cm⁻¹ | | | |
| | 2872.4 cm⁻¹ | | | |
| 3. | 1736 cm⁻¹ | 1750-1720 | cm⁻¹ | carbonyl stretch |
| 4. | 1637.8 cm⁻¹ | 1680-1620 | cm⁻¹ | >C═C< stretch |
| | 1647.4 cm⁻¹ | | | |
| | 1655.1 cm⁻¹ | | | |
| 5. | 1471.9 cm⁻¹ | 1475-1300 | cm⁻¹ | CH bending |
| 6. | 895.1 cm⁻¹ | 1000-650 | cm⁻¹ | aliphatic >C═ |
| | | | | C< stretch |
| 7. | 717.6 cm⁻¹ | 990-650 | cm⁻¹ | RCH═CHR stretch |

CHART 3
3: Nuclear Magnetic Resonance (13c Carbon) Interpretation of EPA
3. ¹³C NMR

| | Multiplicity | Expected δ- | |
|---|---|---|---|
| Obsd δ-value(ppm) | pattern | value | Inference |
| 173.22 | singlet | 155-185 | >C═O gp(carboxylic |
| | | | region) |
| 77.05, 77.37, 77.74 | triplet | — | CDCl3 solvent |
| 0-85 | — | — | aliphatic region |
| 62.07, 68.86 | singlet | — | —CH═CH— |
| 34.19, 34.02 | doublet | triplet | α to carboxylic gp |
| 31.93 | doublet | triplet | βto carboxylic gp |
| 29.70-29.07 | multiplet | multiplet | δto carboxylic gp |
| 28.98 | singlet | singlet | —CH2 gp |
| 27.20, 24.89, | shoulder | — | respective —CH2 gps |
| 24.85, 72.68 | | | |
| 14.09 | singlet | quartet | —CH3 gp |

CHART 4
Nuclear Magnetic Resonance (1H Proton) Interpretation of EPA
4. ¹H-NMR

| | Multiplicity | | |
|---|---|---|---|
| Observed δ-value | pattern | Expected δ-value | Inference |
| 0.826 | triplet | 0.9-1.03 | —CH3 |
| 1.208 | multiplet | 2.03 | |
| 1.462 | multiplet | 1.6 | β to carbonyl |
| 1.946 | multiplet | 1.8-1.9 | α to >C═C< |
| 2.067 | multiplet | — | |
| 2.242 | multiplet | 2.3 | α to carbonyl |
| 2.492 | multiplet | 2.6 | 4-CH2 gps(8H) |
| 3.120 | singlet | | |
| 4.075 | multiplet | 5.3-5.4 | —CH═CH—(8H) |
| 5.3 | singlet | 5.5 | C5-C6 protons |
| 7.25 | m | | |
| 7.43 | m | | |
| 7.51 | m | | |
| 8.36-8.4 | singlet | 10-12 | —OH(1H) |

CHART 5
MASS Interpretation of EPA
5. Mass Spectra of EPA

| | | loss of group/ |
|---|---|---|
| Obsd m/e value | loss of fragment | inference |
| −301.5 | — | m.i |
| 243.0 | 59 | —CH₂COOH |
| 221 | 22 | —CH═CH— |
| 205.0 | 15 (14) | —CH₂ |
| 177 | 28 (26) | —CH₂ |
| 154 | 23 (26) | —CH═CH— |

On the above observation and interpretation, the structure of the (EPA) is found as follows.

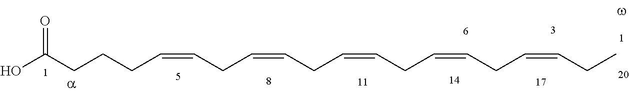 [SMILES: CC/C=C\C/C=C\C/C=C\C/C=C\C/C=C\CCCC(=O)O]

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present invention.

1. A method of isolation of Eicosapentaenoic acid (EPA) comprising the steps of:
a) adding at least one alcoholic solution selected from a group comprising an alcoholic solution of sodium hydroxide, an alcoholic solution of potassium hydroxide, or mixtures thereof to fatty acid sources to form a reaction mixture;
b) stirring the reaction mixture to obtain an upper layer and a lower layer, wherein said upper layer is discarded;
c) adding a ketone selected from a group comprising acetone, ethyl ketone, or methyl ketone to the lower layer to form a second mixture;
d) allowing higher free fatty acids in said second mixture to precipitate;
e) filtering the second mixture to separate the precipitate; and
f) allowing settling in the filtrate to precipitate the EPA and recover said precipitate as a crystalline mass wherein said crystalline mass of the EPA is processed to obtain a dry, directly compressible, free flowing powder of free fatty acid EPA.

2. The method of claim 1, wherein the discarded upper layer of step (b) contains lower fatty acids having less than 20 carbons, triglycerides and other impurities.

3. The method of claim 1, wherein the second mixture obtained from step (c) is stirred before allowing the higher fatty acids to precipitate.

4. The method of claim 1, wherein solids in the lower layer are discarded during filteration in step (e).

5. The method of claim 1, wherein the precipitate formed in step (f) is dried to obtain the EPA as the crystalline mass.

6. The method of claim 3, wherein the precipitate is washed with the ketone to remove impurities and other polyunsaturated free fatty acids, further wherein the precipitated EPA is evaporated to obtain the crystalline mass of the EPA.

7. The method of claim 3, wherein the crystalline mass of the EPA is passed through a sieve to obtain said dry, directly compressible, free flowing powder of free fatty acid EPA.

8. The method as claimed in claim 1, wherein the fatty acid sources are selected from a group comprising mackerel oil, menhaden oil, salmon oil, capelin oil, tuna oil, sardine oil, or cod oil, marine algae, or any other source having EPA attached to triglycerides.

9. The method of claim 5, wherein the marine algae is Schizochytrium sp.

10. The method as claimed in claim 1, wherein the alcoholic solution of sodium hydroxide or the alcoholic solution of potassium hydroxide is selected from a group comprising methanolic solution, ethanolic solution, propanolic solution, butanolic solution or mixtures thereof.

11. A Eicosapentaenoic acid (EPA) in a dry, directly compressible, free flowing powder form.
